(19) United States
(12) Patent Application Publication
(10) Pub. No.: US 2022/0108094 A1
(43) Pub. Date: Apr. 7, 2022

(54) COOKING VESSEL AND RELATED METHOD FOR IDENTIFYING A RECIPE

(71) Applicant: PENSOFAL INTERNATIONAL S.P.A., Napoli (IT)

(72) Inventor: Giovanni SOLLO, Napoli (IT)

(21) Appl. No.: 17/428,257

(22) PCT Filed: Feb. 5, 2020
(86) PCT No.: PCT/IB2020/050906

§ 371 Date: Aug. 3, 2021

(30) Foreign Application Priority Data
Feb. 6, 2019 (IT) 102019000001705

(51) Int. Cl. G06K 7/14; A47J 45/06

(52) U.S. Cl. CPC G06K 7/143; A47J 45/06

(57) ABSTRACT

A cooking vessel (12) comprises a body (14) provided with an inner cooking surface (16) and an outer surface (18). The cooking vessel (12) further comprises at least one handle (20, 22) arranged on the body (14). The vessel is characterized in that said at least one handle (20, 22) is provided with a cryptogram (24) uniquely associable with an internet address, and suitable to be read by an optical reading device (24).

### FIELD OF THE APPLICATION

The present invention concerns a cooking vessel and a method for identifying a recipe using this cooking vessel.

### STATE OF THE ART

As is known, technologies related to the use of smartphones, tablets, or other similar devices may be advantageously applied to the kitchen and in particular to the preparation and cooking of food.

A prime example of such applications are the numerous portals available on the web, which provide cooking recipes. These portals provide a sort of recipe book, which is more convenient and complete than the paper recipe book.

In particular, one of the advantages is that the user is often given the opportunity to search with keywords, linked to the name of a recipe, or to one or more ingredients.

There are also some applications wherein the user is guided step by step in the preparation, for example by integrating videos explaining a particularly important step.

Furthermore, there are complex and automatic cooking systems, for which recipes specific for the type of cooking vessel are available online.

These types of vessels, once the ingredients are prepared, are autonomous in the preparation, which has been predefined beforehand.

It is also known to provide a cryptogram on the inside surface of a pot, which when scanned with a smartphone equipped with a camera, allows the smartphone to automatically connect to a website.

The prior art, although widely used and appreciated, is not without its drawbacks.

First of all, the preparation of some dishes may be conditioned not only by the ingredients that one actually has available, but also by the type of equipment one has available. Therefore, both with regard to traditional recipe books and those available on a website or on an application installed on a smartphone, there is no immediate confirmation that the type of equipment available is actually adapted and sufficient to make the recipe.

In the solutions wherein a recipe book dedicated to the type of equipment is available, these concern automatic devices and methods, which are not normally used for the daily preparation of food, nor for sophisticated and refined dishes.

Finally, if a cryptogram is provided on the inner surface of a pot, it is no longer readable through the smartphone after the pot has been filled.

Thus, if it is filled by mistake before reading the cryptogram with one's smartphone, the possibility of connecting to the relevant website is lost.

### PRESENTATION OF THE INVENTION

The need is thus felt to resolve the drawbacks and limitations cited with reference to the prior art.

Therefore, the need is felt to provide a cooking vessel that allows a simple and effective connection to a relevant website.

Moreover, the need is felt for a cooking vessel that allows one to easily and effectively obtain a connection to a website at any time during the cooking of food.

Furthermore, the need is felt for a cooking vessel and associated cooking method which may be easily used with a smartphone equipped with a camera and internet connection.

These requirements are satisfied by a cooking vessel in accordance with claim 1, and by a procedure for identifying a recipe in accordance with claim 8.

### DESCRIPTION OF THE DRAWINGS

Further features and advantages of the present invention will become more evident from the following description of the preferred and non-limiting examples of embodiment thereof, wherein:

FIG. 1 shows schematically a perspective view of a cooking vessel according to the present invention;

FIG. 2 shows schematically a perspective view of an alternative embodiment of a cooking vessel according to the present invention;

FIGS. 3 and 4 show schematically two plan views from the top of two handles of two cooking vessels according to the present invention;

FIG. 5 shows schematically a handle portion of a cooking vessel according to the present invention; and

FIGS. 6 and 7 show schematically the portion represented in FIG. 5 with two different embodiments of a handle of a cooking vessel according to the present invention.

The elements or parts of elements in common between the embodiments described hereinafter will be indicated at the same numerical references.

### DETAILED DESCRIPTION

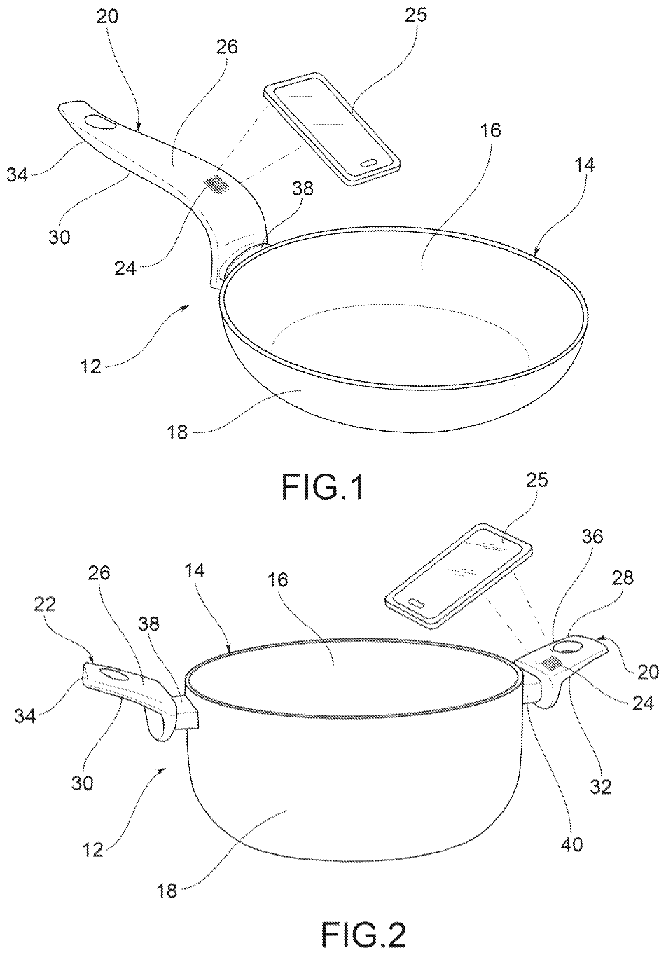

FIG. 1 shows a cooking vessel according to the presentation that is indicated at reference 12.

The cooking vessel 12 comprises, in a manner known per se, a body 14 provided with an inner cooking surface 16 and an outer surface 18.

The body 14 may be of a type known per se, for example made of steel or aluminum. Furthermore, the inner surface 16 may be of a non-stick type.

The cooking vessel 12 further comprises at least one handle 20, 22 provided on the body 14.

The embodiment shown in FIG. 1 shows a cooking vessel 12, in particular a pan, provided with a handle 20.

Instead, the embodiment shown in FIG. 2 shows a cooking vessel 12, in particular a pot, provided with two handles 20, 22.

In accordance with a possible embodiment of the present invention, the cooking vessel may be made of metal, e.g. aluminum, steel, stainless steel, cast iron, copper. In accordance with an alternative embodiment, the cooking vessel may be made of glass, ceramic, porcelain.

In accordance with possible embodiments of the present invention, at least one handle 20, 22 may be applied to the vessel by welding, rivets, bolted connections, etc.

In further embodiments, the at least one handle 20, 22 may be made in one piece with the body 14. The at least one handle may be an edge protruding outwards from the body 14, or also a contoured edge.

For example, in the case of a cooking vessel made of glass, ceramic or porcelain, the at least one handle may be made with a protruding edge, possibly contoured with a slot.

On the at least one handle 20, 22 of the cooking vessel 12 there is provided a cryptogram 24 uniquely associable with an internet address, and suitable to be read by an optical reading device 25.

In this discussion the term cryptogram 24 refers to a graphic representation that may also include alphanumeric characters, which contains information that may be read by means of an optical reading device 25. In particular, examples of cryptograms are linear and two-dimensional barcodes.

In the case wherein the cooking vessel 12 is provided with two or more handles 20, 22, the cryptogram 24 may be provided on at least one of the handles 20, 22.

According to a possible embodiment, the cryptogram 24, uniquely associable with an internet address and adapted to be read by an optical reading device 25, is a QR code.

As is known, the QR code is a special two-dimensional barcode. The code takes the form of a matrix composed of black modules arranged within a white square pattern. Up to 7,089 numeric or 4,296 alphanumeric characters may be contained in a QR code cryptogram.

Advantageously, the format of the matrix of the QR code cryptogram of the present invention is a square with 29 small squares on the side.

In alternative embodiments, the cryptogram 24 may be either a barcode or an alphanumeric code, adapted to be read by the optical reading device 25.

In this respect, the optical reading device 25 may be provided with a computer program suitable to associate this information with an internet address.

In a manner known per se, the at least one handle 20, 22 comprises an upper surface 26, 28 and a lower surface 30, 32.

The lower surface 30, 32 refers to the surface of the handle 20, 22 facing the surface on which the cooking vessel is placed, while the upper surface 26, 28 refers to the surface of the handle opposite the lower surface 30, 32.

In accordance with a possible embodiment of the present invention, the cryptogram 24 is provided on the upper surface 26, 28 of the handle 20, 22.

In this way, the user of the cooking vessel 12 may use the cryptogram 24 without the need to turn over the cooking vessel 12, and thus also during cooking.

In a manner known per se, the handle 20, 22 may comprise a grip 34, 36 and a ferrule 38, 40.

In accordance with a possible embodiment, the handle may be made of a polymeric material, wood, metal, or other materials of a known type.

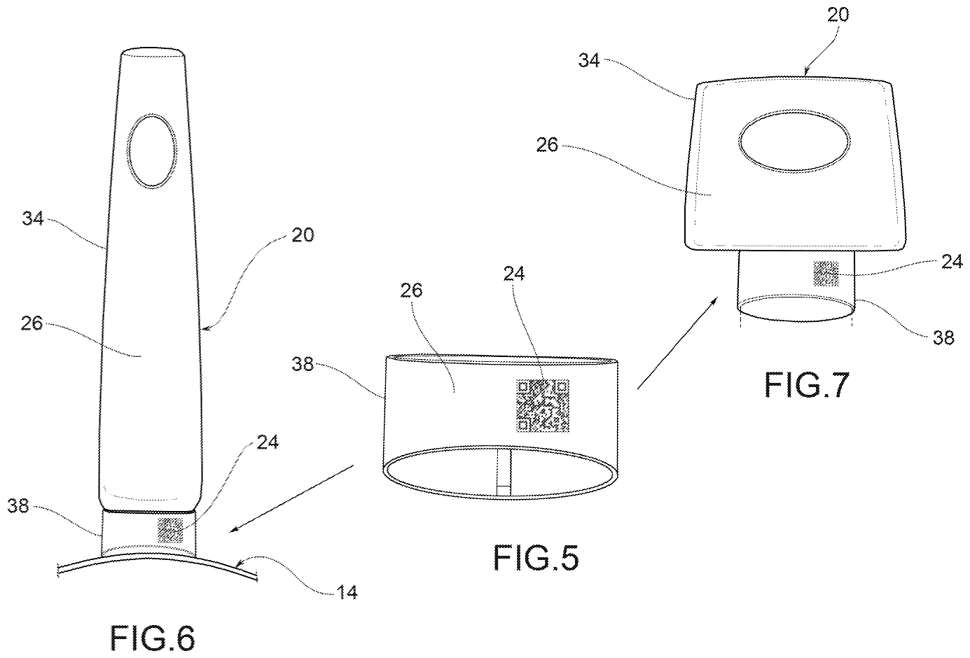

With reference to FIG. 5, the ferrule 38 may be a sleeve, into which a portion of the handle may be inserted.

In accordance with a possible embodiment of the present invention, the ferrule may be made of metal, e.g. aluminum.

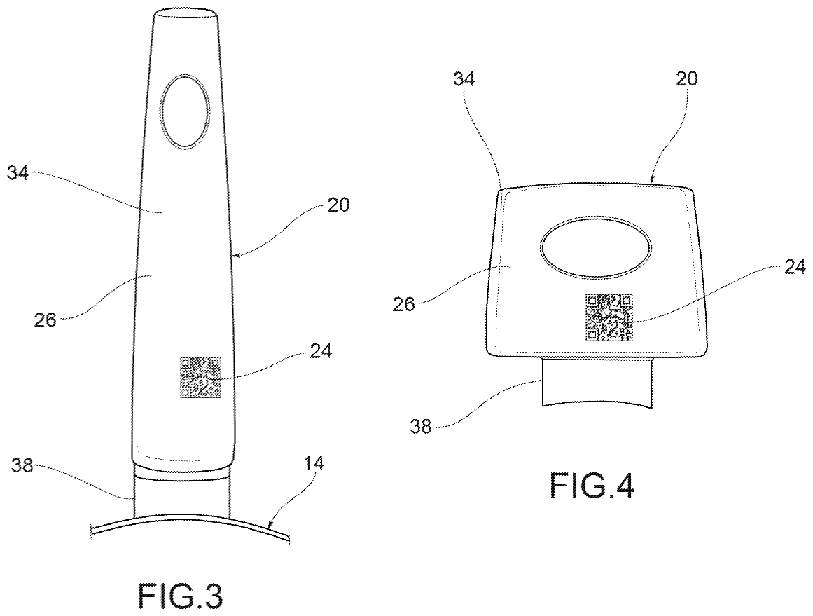

In accordance with a possible embodiment, the cryptogram 24 may be provided on the grip 34, 36. Embodiments of this type are shown for example in FIGS. 1-4.

Advantageously, the cryptogram may be printed on the grip 34, 36. In accordance with alternative embodiments, the cryptogram may be engraved and then colored.

However, other methods for affixing the cryptogram 24 that are known to the person skilled in the art are conceivable.

In a possible alternative embodiment, the cryptogram 24 may be provided on the ferrule 38, 40. Embodiments of this type are shown for example in FIGS. 5-7.

Advantageously, the cryptogram may be printed on the ferrule 38, 40. In accordance with alternative embodiments, the cryptogram may be engraved and then colored.

Consequently, the present invention also has as its subject-matter a method for the identification of a recipe, comprising:
a step wherein a cooking vessel 12 is provided, as described above;
a step wherein an optical reading device 25 suitable to read a cryptogram 24 is provided;
a step wherein the cryptogram 24 is scanned and read by the optical reading device 25;
a step wherein the optical reading device 25 receives information relating to the internet address contained in the cryptogram 24, relating to a recipe.

In accordance with a possible embodiment, the optical reading device 25 may be a smartphone.

The smartphone 25 may be adapted to connect to the internet, and adapted to display the recipe directly once the cryptogram 24 has been read.

The advantages that may be achieved with a cooking vessel and a cooking method according to the present invention are thus now evident.

The advantages that may be achieved with the present invention are thus now evident.

First of all, a vessel for cooking food has been made available that allows a simple and effective connection to a relevant website.

Moreover, the cooking vessel according to the present invention allows one to easily and effectively obtain a connection to a website, at any time during the cooking of the food. Advantageously, the connection may be to a website wherein there is a recipe suited to the type of cooking vessel.

Furthermore, the cryptogram, in the case of the QR code, may be easily read even with a smartphone lacking a specific application.

Moreover, the cryptogram may contain information relating to a generic website relating to the manufacturer of the cooking vessel.

To the embodiments described above, the person skilled in the art may, in order to satisfy specific needs, make changes to or replacements of the described elements with equivalent elements without thereby departing from the scope of the accompanying claims.

In the present discussion, references to the QR code have been made, but other types of codes, such as linear or two-dimensional barcodes, may also be used.

1-10. (canceled)

11. A cooking vessel comprising a body provided with an inner cooking surface and an outer surface, said cooking vessel further comprising:
at least one handle provided on said body;
said vessel being characterized in that said at least one handle is provided with a cryptogram uniquely associable with an internet address, and adapted to be read by an optical reading device.

12. The cooking vessel of claim 11, characterized in that said cryptogram uniquely associable with an internet address, and adapted to be read by an optical reading device is a QR code.

13. The cooking vessel of claim 11, characterized in that said at least one handle comprises an upper surface and a lower surface, said cryptogram being provided on said upper surface.

14. The cooking vessel of claim 11, characterized in that said at least one handle comprises a grip and a ferrule, said cryptogram being provided on said grip.

15. The cooking vessel of claim 11, characterized in that said at least one handle comprises a grip and a ferrule, said cryptogram being provided on said ferrule.

16. The cooking vessel of claim 11, characterized in that it is a pan or a pot.

17. The cooking vessel of claim 11, characterized in that said cryptogram is adapted to be read by a smartphone.

18. A method for identifying a recipe, comprising:
a step wherein a cooking vessel is provided, said cooking vessel comprising:
a body comprising an inner cooking surface and an outer surface; and
at least one handle on said body;
a step wherein an optical reading device adapted to read a cryptogram is provided;
a step wherein the cryptogram is scanned and read by the optical reading device; and
a step wherein the optical reading device receives information relating to the internet address contained in the cryptogram, relating to a recipe.

19. The method of claim 18, characterized in that said optical reading device is a smartphone.

20. The method of claim 19, characterized in that said smartphone is adapted to connect to the internet, and adapted to display said recipe once the cryptogram has been read.
